(19) United States
(12) Patent Application Publication
(10) Pub. No.: US 2008/0123566 A1
(43) Pub. Date: May 29, 2008

(54) Usb Storage Device with Ip Telephone Capable of Providing On-Line Contents

(76) Inventor: Hyok-Jin Jung, Kyoungki-do (KR)

Correspondence Address: Calif Tervo;Palomar Patent, 6387 Caminito Lazaro, San Diego, CA, 92111, US

(21) Appl. No.: 11/793,371

(22) PCT Filed: Jun. 1, 2005
(86) PCT No.: PCT/KR05/01637

§ 371 Date: Jun. 15, 2007

(30) Foreign Application Priority Data
Dec. 29, 2004 (KR) 10-2004-0115848
Apr. 9, 2005 (KR) 10- 2005-0029701

(51) Int. Cl. H04L 12/18

(52) U.S. Cl. 370/271

(57) ABSTRACT

The present invention relates to a Universal Serial Bus (USB) storage device having IP telephone capable of originating/receiving a call and providing on-line content. A USB connector (61) and USB memory (63) are installed in a housing (62). A unique phone number belonging to the USB storage device and a content program, used to automatically connect to the server of an ITSP, are stored in the USB memory (63). The USB storage device includes call origination/reception means enabling Internet telephony, and alarm means for sounding an alarm to recognize an incoming call. When inserted into a USB port of a computer, the USB storage device is automatically connected to the server, and a telephone number is input on a monitor, thus enabling call origination and call reception.

### TECHNICAL FIELD

The present invention relates, in general, to a USB storage device having IP telephone capable of originating/receiving a call and providing on-line content and, more particularly, to a USB storage device having IP telephone capable of originating/receiving a call and providing on-line content, in which a unique phone number belonging to the USB storage device and a content program used to automatically connect to the server of an Internet Telephony Service Provider (ITSP) are stored in USB memory, and which includes a call origination/reception means enabling Internet telephony and an alarm means for sounding an alarm to signal an incoming call, and is operated so that, if the USB storage device is inserted into a USB port of a computer and a transceiver set is connected to the USB storage device, the USB storage device is automatically connected to the server, and is capable of originating a call by inputting a telephone number on a monitor, and also capable of receiving an incoming call.

### BACKGROUND ART

The configuration of a network connected to an Internet telephone can be exemplified as shown in FIG. 1. Reference numeral 10 denotes a user terminal unit that is used to connect to an Internet telephony service provider and includes an Internet telephone 11 and a computer device 12 connected thereto.

Further, the Internet telephone 11 is constructed to include a Digital Signal Processor (DSP) as a processor for processing audio signals and to use a Universal Serial Bus (USB) as an interface for connecting to an audio data line. The USB is connected to the computer device 12 having a USB port, and is operated thereby.

Meanwhile, as well known in the art, the USB interface is a bus interface provided to improve extensibility between a computer and peripherals thereof and convenience to use the computer and the peripherals, and is standardized to provide an improved data rate compared to a typical serial bus and to support a plug-and-plug scheme. Further, the USB interface is standardized to support a Human Interface Device (HID) driver provided for a user's convenience. That is, as is generally known, the HID driver is constructed to conveniently process interfaces between humans and computers and between humans and peripherals, and is included in the Operating System (OS) program of a computer, such as Windows 98 or Windows 2000. Further, the operating program for driving a peripheral using the HID driver is constructed to be suitable for the characteristics of peripherals according to the manufacturing company of a corresponding peripheral. Even in the Internet telephone 11, a predetermined operating program for supporting the HID driver is provided.

Meanwhile, the computer device 12 includes a Web browser (not shown), a modem device for accessing the Internet 20, a cable modem, a communication interface means such as a Local Area Network (LAN) card, and a USB port. The Internet telephone 11 is connected to an Internet Telephony Service Provider (ITSP), such as Dial-Pad, through the computer device 12.

Further, the computer device 12 includes a predetermined client program to process a procedure of connecting to the Internet telephony service provider.

Meanwhile, FIG. 1 shows a single user terminal unit 10 connected to the Internet 20, but actually a plurality of user terminal units 10 is connected to the Internet telephony service provider through the Internet 20. Reference numeral 30 is the server unit of the Internet telephony service provider, which is used to provide a call service to a connecting user through the Internet 20. That is, if packet data corresponding to key data values of a phone number are received from the user terminal unit 10, the sever unit 30 accesses a Public Switched Telephone Network (PSTN) 40 and establishes a call with another party's telephone 50.

Meanwhile, it is preferable that, after the IP address of a user who has subscribed as a member and an Internet phone number corresponding to the IP address are stored in a predetermined storage area of the server unit 30, the user of the Internet telephone 11 receive a call through the Internet phone number under the support of a local central office (not shown).

In this case, if a Dual Tone Multi-Frequency (DTMF) signal corresponding to the Internet phone number is received from the phone 50, the local central office (not shown) transmits predetermined call data including the phone number information to the server unit 30. The server unit 30 transmits calling information to the user terminal unit 10 on the basis of the call data, thus establishing a call connection between the phone 50 and the Internet telephone 11.

In this case, after recognizing the calling information received from the server unit 30, the client program provided in the computer device 12 is constructed to drive the Internet telephone 11 on the basis of the recognized calling information.

Further, FIG. 2 is a circuit diagram showing the internal construction of the typical Internet telephone using a USB port. In FIG. 2, reference numeral 1 denotes a hook switch for outputting a predetermined voltage level signal depending on the hook-state of a handset (not shown) provided outside the Internet telephone 11. For example, in an off-hook state, a high level voltage signal is output through a resistor R, while, in an on-hook state, an output voltage level signal is maintained at a low level.

Further, reference numeral 2 denotes a processor for transmitting/receiving predetermined packet data used to perform voice communication through the USB port of the computer device 12, and then controlling the input/output of audio signals to perform voice communication on the basis of the packet data. In the processor 2, an audio codec is provided to control the input/output of audio signals and is constructed to support Voice over Internet Protocol (VoIP) H. 323, Session Initiation Protocol (SIP), etc., which are protocols used for audio signal processing in the Internet 20.

Meanwhile, if a high level voltage signal from the hook switch 1 is applied to the state signal input terminal DT of the processor 2, the processor 2 transmits predetermined packet data for indicating an off-hook state to the computer device 12 through a packet data input/output terminal UD.

Accordingly, after determining whether the computer device 12 is connected to the Internet 20 and whether a Web browser is running, and executing the Web browser, the client program in the computer device 12 runs a preset Internet phone program, such as Dial-Pad, and transmits predetermined packet data used to control audio input/output of the Internet telephone 11 to the packet data input/output terminal UD. The processor 2 outputs predetermined control data through a serial data input/output terminal SD so that the input/output path of audio signals is switched to the handset of the Internet telephone 11.

Meanwhile, the packet data, input/output through the packet data input/output terminal UD of the processor 2, are composed of predetermined HID packet data used to drive, for example, the above-described HID driver.

Further, if a voltage signal output from the hook switch 1 is switched from a high level in an off-hook state to a low level in an on-hook state, the processor 2 outputs predetermined control data through the serial data input/output terminal SD so that the input/output path of audio signals is switched from the handset to an external terminal used to input/output audio signals.

Therefore, the paths of the audio signal input terminal AI and audio signal output terminal AO of the processor 2 are switched to an external terminal or the handset depending on the on/off hook state of the handset. Thereafter, if a user inputs a required phone number using a key input unit, which will be described later, the processor 2 converts the phone number into packet data and transmits the packet data to the computer device 12. The client program in the computer device 12 transmits the corresponding phone number to the server unit 30 of the Internet telephony service provider through the Internet phone program, thus processing a call connection.

However, the above scheme employs a structure, in which a typical telephone is connected to the USB port of a computer and a user inputs desired numbers or presses number buttons on the telephone while viewing a displayed phone image, so that an Internet telephone is essentially required. Accordingly, the above scheme is problematic in that, when the user moves to a desired place, a call can be made only if an Internet telephone is provided in the desired place, and the above scheme cannot be used in a region or country in which very high speed Internet that can support telephone calls is not available.

Recently, an external Hard Disk Drive (HDD) and a USB memory device using flash memory, etc. are generally used as storage media. Further, if necessary, an adapter having a separate USB port is used to utilize a memory stick-type storage medium used in a digital camera, etc., so that a memory stick is connected to the adapter to read or write data from or in the memory stick.

This scheme can be illustrated as shown in FIG. 3. A USB storage device connected to a computer through a USB connector 61 is implemented using USB memory 63 connected to the terminal of the USB connector 61 in a housing 62. The USB memory 63 includes a controller 64 connected to the USB connector 61, and flash memory 65 for storing data received through the controller 64. The USB connector 61 includes power terminals B1 and B2 and data terminals D1 and D2. The data terminals D1 and D2 are implemented to connect to the input/output terminals UD1 and UD2 of the controller 64 through resistors R1 and R2, respectively. At an output terminal P3, a laser diode LD1 for recognizing the operation of memory is installed.

However, this storage device is problematic in that, since it functions as a simple memory storage device and functions as a storage device that is inserted into the USB port of a typical computer and is used thereby, the storage device cannot provide other functions.

### DETAILED DESCRIPTION OF THE INVENTION

The present invention has been made keeping in mind the above problems, and an object of the present invention is to provide a USB storage device, which allows the function of an IP telephone to be implemented in the USB storage device.

Another object of the present invention is to provide a USB storage device, which allows an Internet telephone capable of receiving a call to be implemented in the USB storage device.

A further object of the present invention is to provide a USB storage device, which automatically enters a state enabling a call to be made to another party (in an environment enabling connection through the Internet regardless of country or region) if the USB storage device is inserted into a computer existing in any country, thus allowing anyone to easily make an IP call.

In order to accomplish the above objects, the present invention provides a Universal Serial Bus (USB) storage device, the USB storage device being implemented so that a USB connector and USB memory are installed in a housing, wherein a unique phone number belonging to the USB storage device and a content program (client program) used to automatically connect to a server of an Internet telephony service provider (ITSP) are stored in the USB memory, and the USB storage device comprises call origination/reception means enabling Internet telephony, and alarm means for sounding an alarm to signal an incoming call, and the USB storage device is operated so that, if it inserted into a USB port of a computer, the program is automatically run, the USB storage device is automatically connected to the server, and a telephone number is input on a monitor, thus enabling a call to be made.

That is, the present invention provides a Universal Serial Bus (USB) storage device having IP telephone capable of originating/receiving a call and providing on-line content, the USB storage device being implemented so that a USB connector and USB memory are installed in a housing, wherein a unique phone number belonging to the USB storage device and a content program used to automatically connect to a server of an Internet telephony service provider (ITSP) are stored in the USB memory, and the USB storage device comprises call origination/reception means enabling Internet telephony, and alarm means for sounding an alarm to signal an incoming call, and the USB storage device is operated so that, if it inserted into a USB port of a computer, the USB storage device is automatically connected to the server, and a telephone number is input on a monitor, thus enabling a call to be made.

The call origination/reception means comprises a codec unit including an analog/digital converter and a digital/analog converter provided in the housing to enable call origination and reception, the codec unit being electrically connected to one input/output terminal of a controller in the USB memory, a connection jack formed on the housing to allow a transceiver set for transmission and reception to be inserted thereinto and to be used, and a call switch installed on the housing to stop operation of the alarm means and establish a call connection.

The alarm means may be a buzzer operating through a buzzer line switch connected to one data terminal of the USB connector when an incoming call is received.

### DESCRIPTION OF DRAWINGS

FIG. 1 is a view showing an example of the construction of a typical Internet telephone;

FIG. 2 is a block diagram of the Internet telephone of FIG. 1;

FIG. 3 is a view showing the construction of a typical USB storage device;

FIG. 4 is a block diagram of a USB storage device according to the present invention;

FIG. 5 is a perspective view showing the USB storage device according to the present invention;

FIG. 6 is a block diagram of a USB storage device according to another embodiment of the present invention;

FIG. 7 is a view showing an example of screen configuration for call connection, which shows an example of the use of the present invention;

FIG. 8 is a flowchart of a method of providing on-line content; and

FIG. 9 is a view showing an example of screen configuration for call connection, which shows another example of the use of the present invention.

### BEST MODE

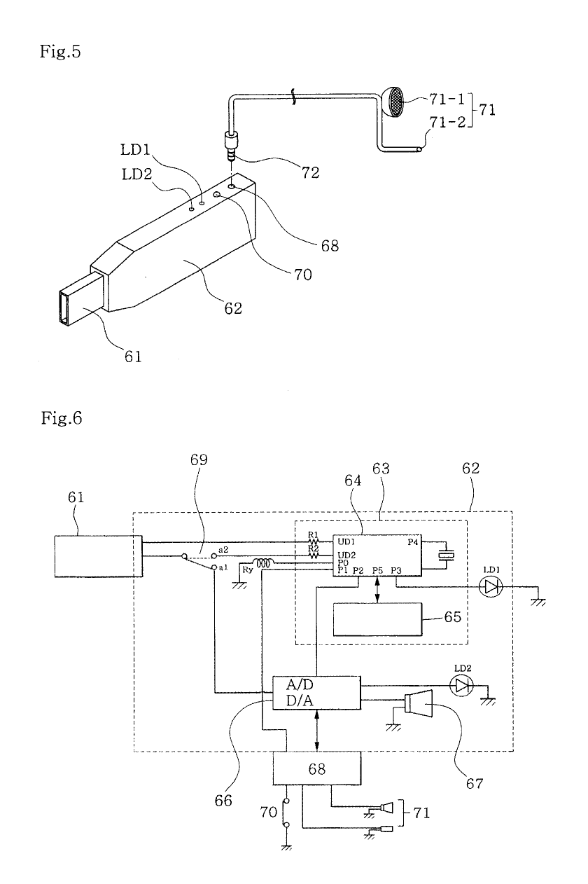

For an embodiment of the present invention, the block diagram of FIG. 4 and the perspective view of FIG. 5, showing the construction of a device, can be illustrated. In a USB storage device in which a USB connector 61 and USB memory 63 are installed in a housing 62, a unique phone number belonging to the USB storage device and a content program (a predetermined client program), used to automatically connect to a server of an Internet Telephony Service Provider (ITSP), are stored in the USB memory 63, and the USB storage device includes a call origination/reception means enabling Internet telephony and an alarm means for sounding an alarm to signal an incoming call. The USB storage device is operated so that, if it is inserted into a USB port of a computer, the USB storage device is automatically connected to a server and executed, and a telephone number is input on a monitor, thus enabling a call to be made.

The call origination/reception means includes a codec unit 66 which has an analog/digital converter and a digital/analog converter provided in the housing 62 to enable call origination and reception and which is electrically connected to one input/output terminal P2 of a controller 64 in the USB memory 63, a connection jack 68 formed on the housing 62 to allow a transceiver set 71 for transmission and reception to be inserted thereinto and to be used, and a call switch 70 installed on the housing 62 to stop the operation of the alarm means and establish a call connection.

As an example, the alarm means may be implemented using a buzzer 67 operating through a buzzer line switch 69 connected to one data terminal of the USB connector 61 when an incoming call is received, or a sound chip capable of generating a sound similar to that of the buzzer 67.

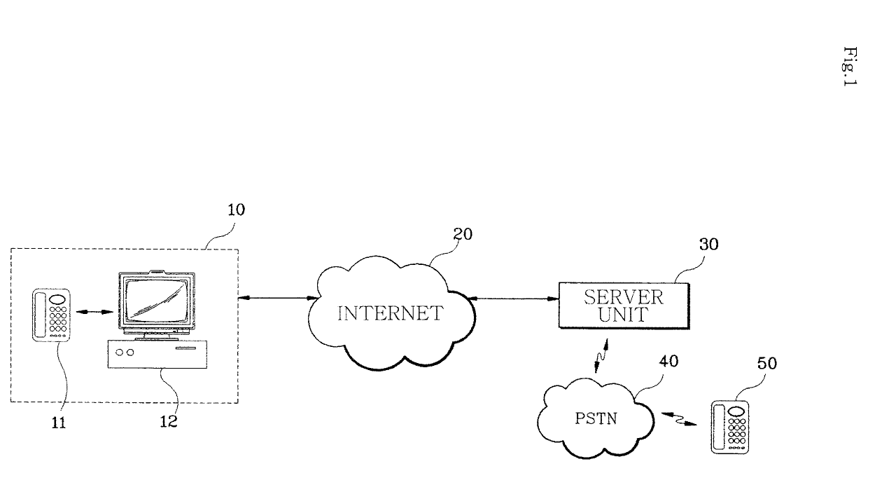

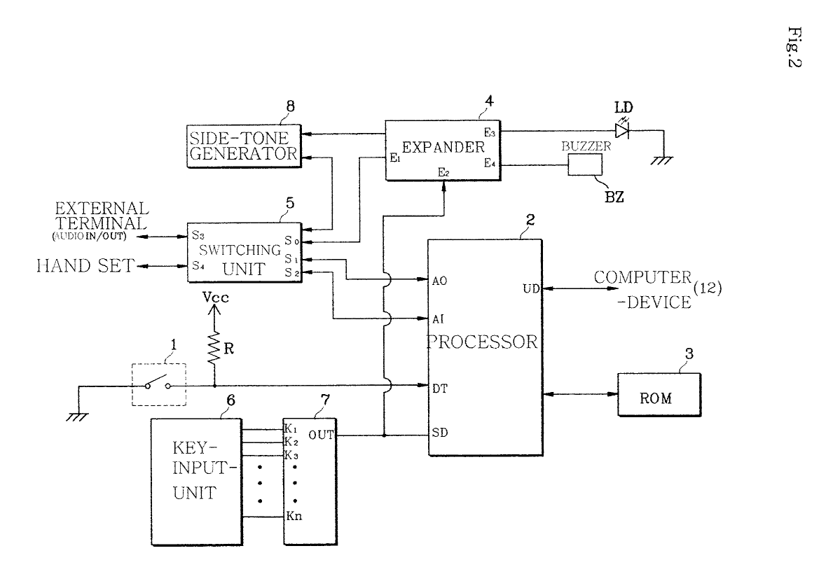

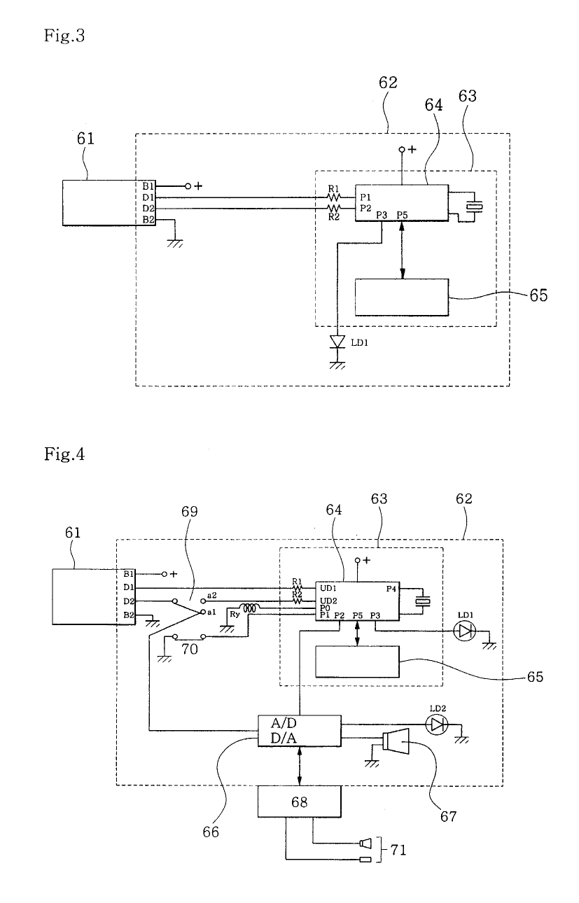

In detail, the USB storage device includes the codec unit 66 which has an analog/digital converter and a digital/analog converter provided in the housing 62 to enable call origination and reception and which is electrically connected to one input/output terminal P2 of the controller 64 in the USB memory 63, the buzzer 67 operating through the buzzer line switch 69 connected to one data terminal of the USB connector 61 when an incoming call is received, the connection jack 68 formed on the housing 62 to allow a transceiver set 71 for transmission and reception to be inserted thereinto and to be used, and the call switch 70 installed on the housing 62 to stop the operation of the buzzer and establish a call connection. In the controller 64 or flash memory 65, a phone number, allocated by the Internet telephony Service Provider (ITSP) enabling the use of the IP telephone, and telephone charges are stored. Further, a content program (actually, the client program in FIG. 1) allowing an initial operation of performing authentication through the automatic connection to the server to be performed simultaneously with plug-in is stored in the controller 64 or the flash memory 65. The codec unit 66 for performing the IP telephone function complies with standard protocols (Session Initiation Protocol: SIP, H. 323, etc.), and is defined to include typical audio and video processing.

The buzzer line switch 69 installed on one input terminal of the USB memory controller 64 includes a first switching terminal a1 connected to one data terminal of the USB connector 61 in a normal on state and adapted to apply a signal to the codec unit 66 for driving the buzzer 67, and a second switching terminal a2 connected to one input/output terminal UD2 of the controller 64.

The first switching terminal a1 is in a normal on state, and a relay Ry for operating through the output terminal P0 of the controller 64 at the time of call connection for communication is provided. When the relay Ry is operated, the terminal a1 is disconnected and the terminal a2 is connected.

LD2 denotes a buzzer lamp lighted simultaneously with the use of the buzzer 67. Reference numeral 71-1 denotes a receiver constituting the transceiver set 71, and 71-2 denotes a microphone for transmission. At the same time that the call switch 70 constituting the present invention is operated, the controller 64 drives the relay Ry through the output terminal PO, so that the connection point of the buzzer line switch 69 is changed to the terminal a2 from the terminal a1, and the USB connector 61 is connected to the controller 64, thus enabling a call to be made. A mechanical switch for changing a connection point from the terminal a1 to the terminal a2 in conjunction with the call switch 70 can be used.

FIG. 6 illustrates another embodiment of the present invention, which is similar to that of FIG. 4, but is constructed so that the call switch 70 is additionally installed on the connection line of the transceiver set 71.

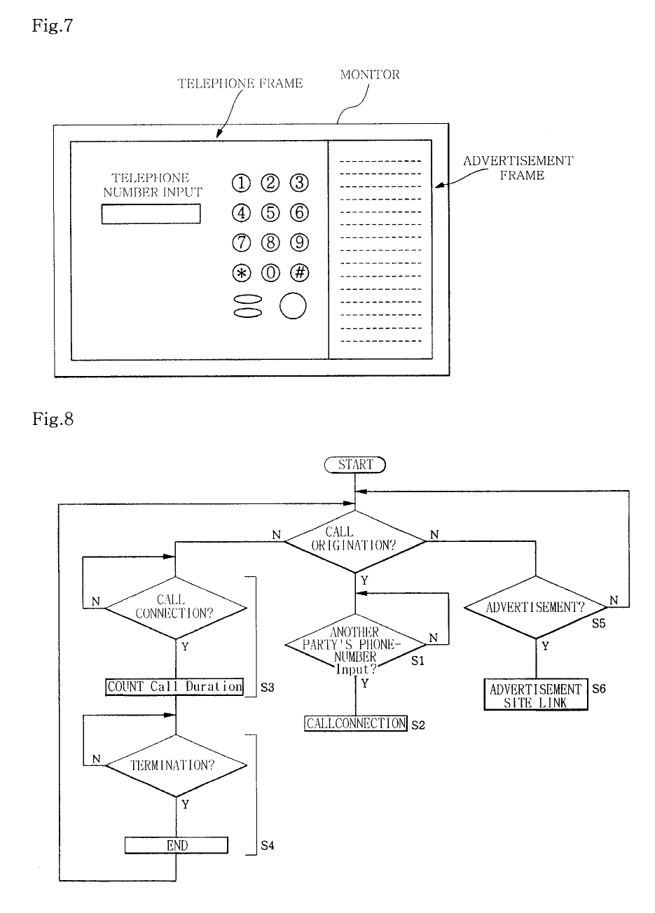

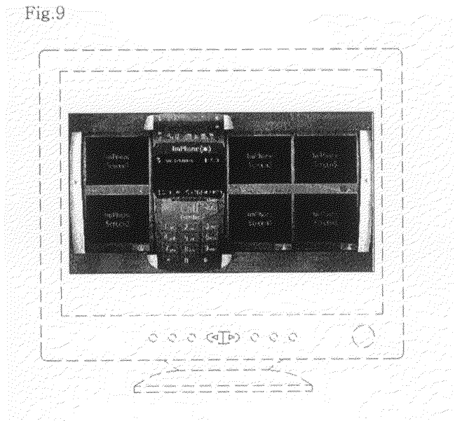

The present invention having the above construction is described with reference to the flowchart of FIG. 8. In the present invention, the USB connector 61 is inserted into the USB port of the computer in the state shown in FIG. 5. Then, the device of the present invention is automatically executed in the connecting computer depending on stored content when the USB storage device is connected to the Internet (when the device of the present invention is connected to the USB port) through the program (a client program used to automatically connect to a server) stored in the flash memory 65 to be automatically run in the present invention (when the device of the present invention is connected to the USB port). Accordingly, the user of the present invention is authenticated through the server of the Internet telephony service provider (a company for allocating a phone number, charging a fee or selling the service in an advance payment manner) using the IP phone number allocated to the user of the present invention and subscription information, over the Internet. On the initial screen of the connecting computer, the above procedures are processed in a batch and only a screen allowing another party's phone number to be input is displayed, for example, as shown in FIG. 7 or 9. Then the user (subscriber) inputs a desired phone number to a phone number input field (of course, locations of corresponding numbers on the screen can be pressed using a mouse, etc.) at step S1. Depending on the pressed numbers, the main server of the Internet telephony service provider establishes a call connection with the other party, thus enabling a call to be made (S2). The server counts a call duration, and charges accumulated fees or sequentially subtracts fees from a prepaid amount.

In the meantime, if an incoming call is received from another party, the buzzer 67, the alarm means, is sounded through the connection line of the codec unit 66 from the USB connector 61 and the terminal a1 in a normal on state. The subscriber recognizes the reception of an incoming call, and presses the call switch 70 on the housing 62 (FIG. 4) or presses the call switch 70 attached to the transceiver set 71. Then, the controller 64 recognizes the pressing of the call switch 70, and drives the relay Ry through the output terminal PO. As the relay Ry is driven, the terminal a1 connected to one terminal of the USB connector 61 through a solid line is turned off, the connection point is changed to the terminal a2 indicated by a dotted line, and the terminal a2 is turned on. Accordingly, a data line input through the terminal (for example, D2) of the USB connector 61 is applied to the codec unit 66 through the input/output terminal UD2 (P2) of the controller 64. Simultaneously, the provision of a signal to the buzzer 67 is interrupted and the operation of the buzzer 67 is stopped, thus allowing communication to be performed at step S3.

In this way, if the communication is progressing and is then terminated, the call switch 70 is pressed again. Then, the controller 64 recognizes the pressing of the call switch 70, interrupts the signal applied to the output terminal PO and turns off the relay Ry, thus the device of the present invention enters a standby state with respect to the buzzer 67 through the terminal a1 at step S4.

Meanwhile, the present invention is implemented so that an advertisement frame shown in FIG. 7 is displayed on the screen of the computer in a standby state or during communication. If the user clicks the advertisement at step S5, the corresponding advertisement site is linked and displayed at step S6.

In the above process, although call origination and reception of the present invention are described, the Internet phone number system (Korean Pat. Registration Nos. 0398350 and 0394823) enabling the Internet telephony through the Internet Telephony Service Provider (ITSP), technology for communicating using typical telephones (Korean Pat. Registration Nos. 0375440 and 0392586), technology for charging for the usage of Internet phones (Korean Pat. Registration No. 0405594), Internet voice communication technology in a firewall environment, etc. are provided by the server, thus ensuring consistent speech quality in an Internet telephone, charging a communication fee or allowing a communication fee to be prepaid, recognizing information about a client anywhere in the world the moment the Internet is accessed, and consequently providing stable speech quality. Accordingly, descriptions of these source technologies are omitted.

### INDUSTRIAL APPLICABILITY

As described above, the present invention stores contents enabling IP telephony in USB memory, and automatically performs authentication in conjunction with a server instead of a user through a content program if a USB connector is inserted into a computer, so that the user can easily make a call merely by pressing the phone number of another party.

Therefore, the present invention is implemented so that, if the user carries a small-sized USB storage device formed in a finger shape and connects the USB storage device to the USB port of any computer, the USB storage device is automatically connected to the server linked to an Internet Telephony Service Provider (ITSP) the moment the USB storage device is connected to the USB port. Therefore, an IP telephone can be used even in a place in which no telephone exists, and old and young, having difficulty using a computer, can easily use the IP telephone. Of course, the unique function of the memory storage device can be maintained.

Further, if the present invention includes an advertisement function in content, and allows an advertiser to pay for the cost of the USB storage device, a user minimizes the cost required to purchase the device and may freely utilize the device without a burden, and the present invention contributes to the reduction of communication fees of users due to a decreased usage fee according to the characteristics of the IP telephone.

Further, the present invention implements a storage device enabling Internet telephony, in which a call reception alarm means, such as a buzzer, is provided in the housing of flash memory, so that a flash memory-type storage device capable of receiving a call can be implemented for the first time in the world. Accordingly, a small-sized flash memory storage device is extended to a composite commodity for completely implementing call originating/reception with a typical telephone, as well as other Internet telephones, thus the sales of the storage devices can be maximized.

1. A Universal Serial Bus (USB) storage device having IP telephone capable of originating/receiving a call and providing on-line content, the USB storage device being implemented so that a USB connector (61) and USB memory (63) are installed in a housing (62), wherein:
a unique phone number belonging to the USB storage device and a content program used to automatically connect to a server of an Internet telephony service provider (ITSP) are stored in the USB memory, and
the USB storage device comprises,
call origination/reception means enabling Internet telephony; and
alarm means for sounding an alarm to signal an incoming call, and
the USB storage device is operated so that, if it inserted into a USB port of a computer, the USB storage device is automatically connected to the server, and a telephone number is input on a monitor, thus enabling a call to be made.

2. The USB storage device having IP telephone according to claim 1, wherein the call origination/reception means comprises:
a codec unit (66) including an analog/digital converter and a digital/analog converter provided in the housing (62) to enable call origination and reception, the codec unit (66) being electrically connected to one input/output terminal (P2) of a controller (64) in the USB memory (63);
a connection jack (68) formed on the housing (62) to allow a transceiver set (71) for transmission and reception to be inserted thereinto and to be used; and
a call switch (70) installed on the housing (62) to stop operation of the alarm means and establish a call connection.

3. The USB storage device having IP telephone according to claim 1, wherein the alarm means is a buzzer (67) operating through a buzzer line switch (69) connected to one data terminal of the USB connector (61) when an incoming call is received.

4. A Universal Serial Bus (USB) storage device having IP telephone capable of originating/receiving a call and providing on-line content, the USB storage device being implemented so that a USB connector (61) and USB memory (63) are installed in a housing (62), wherein:
a unique phone number belonging to the USB storage device and a content program used to automatically connect to a server of an Internet telephony service provider (ITSP) are stored in the USB memory, and
the USB storage device comprises,
a codec unit (66) including an analog/digital converter and a digital/analog converter provided in the housing (62) to enable call origination and reception, the codec unit (66) being electrically connected to one input/output terminal (P2) of a controller (64) in the USB memory (63);
a buzzer (67) operating through a buzzer line switch (69) connected to one data terminal of the USB connector (61) when an incoming call is received;
a connection jack (68) formed on the housing (62) to allow a transceiver set (71) for transmission and reception to be inserted thereinto and to be used; and
a call switch (70) installed on the housing (62) to stop operation of the alarm means and establish a call connection.

5. The USB storage device according to claim 4, wherein the buzzer line switch (69) installed at one input terminal of the USB memory controller (64) comprises:
a first switching terminal (a1) connected to one data terminal of the USB connector (61) in a normal on state and adapted to apply a signal to the codec unit (66) for driving the buzzer (67); and
a second switching terminal (a2) connected to one input/output terminal (UD2) of the controller (64).

6. The USB storage device having IP telephone according to claim 5, wherein the first switching terminal (a1) is in a normal on state, and a relay (Ry) for operating through an output terminal (PO) of the controller (64) at the time of a call connection for communication is provided, the first switching terminal (a1) being disconnected when the relay (Ry) is operated.
